(19) United States
(12) Patent Application Publication
(10) Pub. No.: US 2014/0069769 A1
(43) Pub. Date: Mar. 13, 2014

(54) BANKNOTE HANDLING APPARATUS

(71) Applicants: Hitoshi Kobayashi, Himeji-shi (JP); Shingo Hashimoto, Himeji-shi (JP); Kazuhiko Takahashi, Himeji-shi (JP)

(72) Inventors: Hitoshi Kobayashi, Himeji-shi (JP); Shingo Hashimoto, Himeji-shi (JP); Kazuhiko Takahashi, Himeji-shi (JP)

(73) Assignee: GLORY LTD., Himeji-shi, Hyogo-ken (JP)

(21) Appl. No.: 14/000,687

(22) PCT Filed: Feb. 20, 2012
(86) PCT No.: PCT/JP2012/054010

§ 371 Date: Nov. 22, 2013

(30) Foreign Application Priority Data
Feb. 22, 2011 (JP) 2011036338
Feb. 22, 2011 (JP) 2011036345

(51) Int. Cl. G07D 11/00

(52) U.S. Cl. CPC G07D 11/00
USPC 194/206

(57) ABSTRACT

In a banknote handling apparatus capable of dealing with a depositing/dispensing process by a banknote cassette and a manual depositing/dispensing process, the banknote handling apparatus enables a depositing process without dispensing a reject banknote, which has been deposited from the banknote cassette, to the outside. A banknote accounting apparatus 22 capable of receiving a banknote from banknote feeding units (a banknote receiving unit 201a, a banknote cassette 30a) includes: a transport unit 230a configured such that the banknote feeding unit is connected thereto, the transport unit configured to transport a received banknote; a recognition unit 240a configured to recognize the banknote being transported; an apparatus-internal reject unit 224a configured to store a reject banknote inside the apparatus; an apparatus-external reject unit 22a configured to dispense a reject banknote outside the apparatus; a unit deciding part configured to decide the banknote feeding unit for feeding a banknote; and a control unit configured to decide, when the recognition unit recognizes a banknote having been received from the banknote feeding unit as a reject banknote, to which one of the apparatus-internal reject unit 224a and the apparatus-external reject unit 222a the reject banknote is transported, based on the banknote feeding unit having fed the banknote.

### TECHNICAL FIELD

The present invention relates to a banknote handling apparatus. For example, the present invention pertains to a banknote handling apparatus configured to replenish a cash settlement apparatus installed in a checkout counter of a store with banknotes, and configured to collect banknotes from the cash settlement apparatus.

### BACKGROUND ART

In order that cash (a banknote, a coin) is handed over between a clerk and a customer in a checkout counter of a store, a cash settlement apparatus has been conventionally used. The cash settlement apparatus has a function for counting cash having been put thereinto, for storing the cash, and for dispensing cash stored therein as change. Generally, the checkout counter is composed of a banknote settlement apparatus (banknote change machine), a coin settlement apparatus (coin change machine) and a money register such as a POS (Point Of Sales) register, which are communicably connected to each other.

On the other hand, in a back office of the store, in order that cash such as a change fund is loaded (replenished) to the cash settlement apparatus installed in the store, or that sales proceeds in the cash settlement apparatus are collected, a cash accounting apparatus is used. The cash accounting apparatus has a function for storing (depositing) cash having been collected from the cash settlement apparatus, and for dispensing cash to be loaded to the cash settlement apparatus. The cash accounting apparatus includes a banknote accounting apparatus and a coin accounting apparatus.

In recent years, there has been proposed to use a cassette for transporting cash (hereinafter referred to as “cash transport cassette”) in order to ensure security when cash is transported between a cash settlement apparatus and a cash accounting apparatus.

Citation 1 discloses a system for transporting banknotes between a cash station (10) including a cash safe (12) and a teller safe (26) including a docking station (28), with the use of a banknote container (14) capable of containing banknotes. In addition, Citation 2 discloses a replenishing and collecting cassette (8) configured to collect and store banknotes.

Patent Document 1: EP2031567B

Patent Document 2: JP2007-034522A

### SUMMARY OF THE INVENTION

Actually, there is case in which a banknote settlement apparatus cannot deal with a depositing/dispensing process by a cash transport cassette for containing banknotes (hereinafter referred to as “banknote cassette”), and a clerk manually deposits and dispenses banknotes. In order to cope with this case, a banknote accounting apparatus is preferably capable of not only dealing with a depositing/dispensing process by the banknote cassette, but also dealing with the conventional manual depositing/dispensing process.

In addition, conventionally, a banknote accounting apparatus is configured to recognize a denomination, an authenticity, a suspiciousness in authenticity, a fitness, an version and so on of a deposited banknote, and configured to dispense an unrecognizable banknote as a reject banknote to the outside of the apparatus. However, when a banknote is deposited to the banknote accounting apparatus by using the banknote cassette, it is not preferable to dispense a reject banknote having been deposited from the banknote cassette to the outside of the banknote accounting apparatus, because of inconsistency in terms of security securement.

Thus, the object of the present invention is to enable a depositing process without dispensing a reject banknote, which has been deposited from a banknote cassette, to the outside, in a banknote accounting apparatus (banknote handling apparatus) capable of dealing with both a depositing/dispensing process by the transport cassette and a manual depositing/dispensing process.

A banknote handling apparatus in one embodiment of the present invention is a banknote handling apparatus configured to receive a banknote from at least two kinds of banknote feeding units, the banknote handling apparatus comprising: a transport unit configured such that the banknote feeding unit is connected thereto, the transport unit configured to transport a received banknote; a recognition unit configured to recognize the banknote being transported; an apparatus-internal reject unit configured to store a reject banknote inside the banknote handling apparatus; an apparatus-external reject unit configured to dispense a reject banknote outside the banknote handling apparatus; a unit deciding part configured to decide the banknote feeding unit for feeding a banknote; and a control unit configured to decide, when the recognition unit recognizes a banknote having been received from the banknote feeding unit as a reject banknote, to which one of the apparatus-internal reject unit and the apparatus-external reject unit the reject banknote is transported, based on the banknote feeding unit having fed the banknote.

In the banknote handling apparatus in the one embodiment of the present invention, it is preferable that the unit deciding part is configured to decide the banknote feeding unit for feeding a banknote, based on a connection condition of the banknote feeding unit to the transport unit.

The banknote handling apparatus in the one embodiment of the present invention preferably further includes a process reception unit configured to receive an instruction for process, wherein the unit deciding part is configured to decide the banknote feeding unit for feeding a banknote, based on process contents having been received by the process reception unit.

In the banknote handling apparatus in the one embodiment of the present invention, it is preferable that the banknote feeding units are: a banknote receiving unit configured to receive a banknote(s) from outside and configured to feed the banknotes one by one; and a banknote cassette configured to store a banknote therein and configured to feed the banknote stored therein.

In the banknote handling apparatus in the one embodiment of the present invention, it is preferable that the control unit is configured to perform a control process such that a reject banknote having been received from the banknote receiving unit is transported to the apparatus-external reject unit, and that a reject banknote having been received from the banknote cassette is transported to the apparatus-internal reject unit.

The banknote handling apparatus in the one embodiment of the present invention preferably further includes a process reception unit configured to receive an instruction for process, wherein the control unit is configured to perform a control process such that a reject banknote having been received from the banknote cassette is transported to the apparatus-external reject unit, based on an instruction having been received by the process reception unit.

In the banknote handling apparatus in the one embodiment of the present invention, it is preferable that the control unit is configured to perform a control process such that a predetermined reject banknote having been received from the banknote cassette is transported to the apparatus-external reject unit, based on information in a memory unit of the banknote cassette, related to a stored banknote.

The banknote handling apparatus in the one embodiment of the present invention preferably further includes a storing unit configured to store a banknote, wherein the control unit is configured to perform a control process, when a banknote having been fed out from the storing unit is recognized as a reject banknote by the recognition unit, such that the reject banknote is transported to the apparatus-internal reject unit.

A banknote handling apparatus in one embodiment of the present invention is a banknote handling apparatus including a transport unit configured to receive a banknote from an end portion thereof and configured to transport the banknote into the banknote handling apparatus; and a banknote-feeding-unit connecting unit on which at least two kinds of banknote feeding units can be attached thereon, the banknote-feeding-unit connecting unit configured to connect the banknote feeding unit and the transport unit to each other such that a banknote having been fed out from the banknote feeding unit is transported from the end portion of the transport unit.

In the banknote handling apparatus in the one embodiment of the present invention, it is preferable that the banknote feeding units are a banknote receiving unit configured to receive a banknote(s) from outside and configured to feed the banknotes one by one; and a banknote cassette configured to store a banknote therein and configured to feed the banknote stored therein.

In the banknote handling apparatus in the one embodiment of the present invention, it is preferable that the banknote receiving unit is integrally formed with the banknote handling apparatus; the banknote receiving unit is configured to be movable between a first position at which the banknote receiving unit is connected to the transport unit and a second position at which the banknote receiving unit is disconnected from the transport unit; and when the banknote receiving unit is placed on the second position, the banknote cassette is attachable to the first position.

In the banknote handling apparatus in the one embodiment of the present invention, it is preferable that the banknote receiving unit can be attached to and detached form the banknote handling apparatus.

According to the banknote handling apparatus of the present invention, a banknote, which has been deposited from the banknote feeding unit with its security being ensured, can be transported to the apparatus-internal reject unit to be stored therein. Thus, a banknote security can be maintained.

### BRIEF DESCRIPTION OF THE DRAWINGS

FIG. 1 is a block view showing a structural example of a cash management system 1 in accordance with an embodiment of the present invention.

FIG. 2 is a view showing an example of an appearance of a cash accounting apparatus 21.

FIG. 3 is a block view showing a structural example of a banknote accounting apparatus 22.

Each of FIG. 4A and FIG. 4B is sectional view showing an example of an inside structure of the banknote accounting apparatus 22, in which FIG. 4A shows a condition where a banknote receiving unit 201a is attached to a depositing unit 210a, and FIG. 4B shows a condition in which a banknote cassette 30a is attached to the depositing unit 210a.

Each of FIG. 5A and FIG. 5B is a view for explaining a depositing process of the banknote accounting apparatus 22, in which FIG. 5A shows a banknote transport route when the banknote receiving unit 201a is attached, and FIG. 5B shows a banknote transport route when the banknote cassette 30a is attached.

FIG. 6 is a view for explaining a dispensing process of banknote accounting apparatus 22, in which FIG. 6A shows banknote transport route when the banknote receiving unit 201a is attached, and FIG. 6B shows a banknote transport route when the banknote cassette 30a is attached.

FIG. 7A is a view showing a banknote transport route in a replenishing process of the banknote accounting apparatus 22, and FIG. 7B is a view showing a banknote transport route in a collecting process of the banknote accounting apparatus 22.

FIG. 8 is a sectional view showing an inside structure of a banknote accounting apparatus 22X.

Each of FIG. 9A and FIG. 9B is a perspective view of the banknote accounting apparatus 22 in a first embodiment.

Each of FIG. 10A and FIG. 10B is a perspective view of the banknote accounting apparatus 22 in a second embodiment.

Each of FIG. 11A and FIG. 11B is a perspective view of the banknote accounting apparatus 22 in a third embodiment.

### MODE FOR CARRYING OUT THE INVENTION

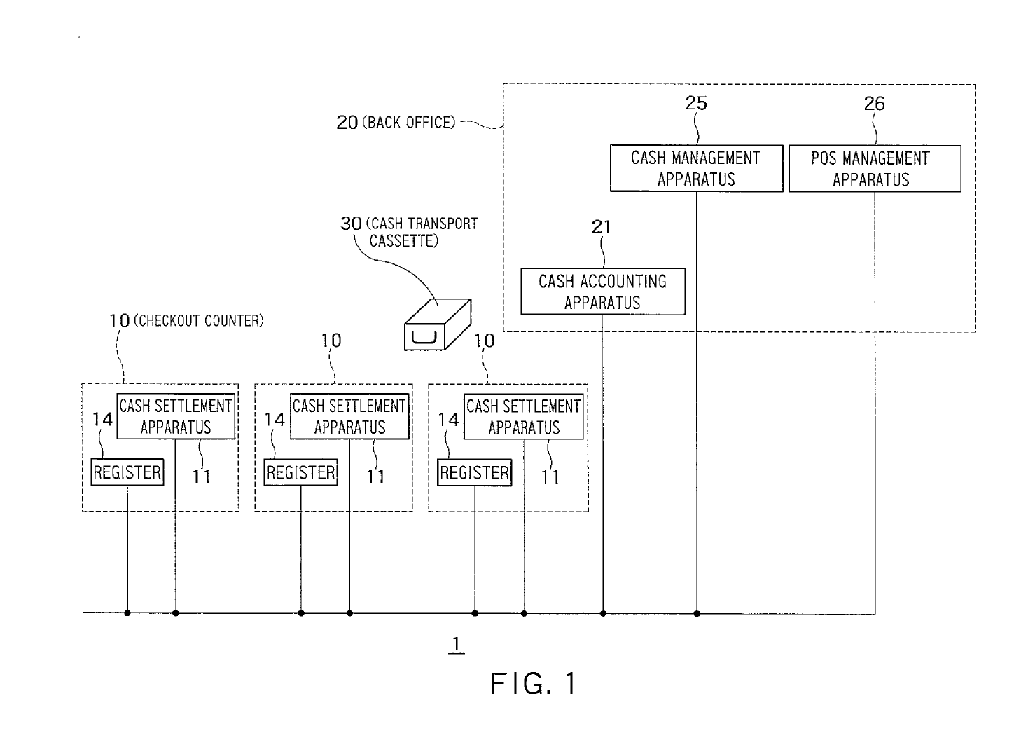

A cash management system 1 shown in FIG. 1 is described as an example of a system in which a banknote accounting apparatus in this embodiment is used.

FIG. 1 is a block view showing a structural example of the cash management system 1. The cash management system 1 is a system configured to handle and manage cash having been received by a clerk from a customer and cash to be paid from the clerk to the customer.

The cash management system 1 is composed of a checkout counter 1 installed in a checkout area in a store and configured to deposit and dispense cash handed over between a clerk and a customer, a back office 20 configured to manage cash in the checkout counter 10 and products, and a cash transport cassette 30 configured to transport cash between the checkout counter 10 and the back office 20.

The checkout counter 10 includes a cash settlement apparatus 11 configured to deposit and dispense cash so as to perform a settlement process with respect to a customer, and a register 14. The register 14 is, for example, a POS register to be operated by a clerk or a self checkout register to be operated by a customer. In FIG. 1, the checkout area includes the three checkout counters 10.

The cash settlement apparatus 11 is operated by a clerk through the register 14, and is used in a settlement process between a clerk and a customer. For example, the cash settlement apparatus 11 deposits expense paid by a customer or dispenses change to be paid to the customer. The cash settlement apparatus 11 is communicably connected to the register 14 and is configured to perform a settlement process in cooperation with the register 14 corresponding thereto. The cash settlement apparatus 11 may be integrally formed with the register 14.

The back office 20 includes a cash accounting apparatus 21, a cash management apparatus 25 and a POS management apparatus 26. The cash accounting apparatus 21 is communicably connected to the cash settlement apparatuses 11, and is configured to dispense a change fund to be loaded to the cash settlement apparatuses 11, or configured to deposit sales proceeds having been collected from the cash settlement apparatuses 11. The cash management apparatus 25 is communicably connected to the cash settlement apparatuses 11 and the cash accounting apparatus 21 through a LAN (Local Area Network) or the like. The cash management apparatus 25 is configured to manage cash stored in the cash settlement apparatuses 11 and the cash accounting apparatus 21. For example, the cash management apparatus 25 is configured to manage cash having been settled in the respective cash settlement apparatuses 11, and cash passed between each cash settlement apparatus 11 and the cash accounting apparatus 21. In addition, the cash management apparatus 25 may monitor whether the cash transport cassette 30 is attached or not on the cash settlement apparatus 11 or the cash accounting apparatus 21. The POS management apparatus 26 is configured to manage a flow of commercial products. Since the flow of commercial products is not directly related to the present invention, detailed description of the POS management apparatus 26 is omitted.

The cash transport cassette 30 can be attached to and detached from the cash settlement apparatus 11 and the cash accounting apparatus 21. When the cash transport cassette 30 is attached to the cash settlement apparatus 11 or the cash accounting apparatus 21, the cash transport cassette 30 can pass cash between the cash transport cassette 30 and the cash settlement apparatus 11, or pass cash between the cash transport cassette 30 and the cash accounting apparatus 21. On the other hand, when the cash transport cassette 30 is detached from the cash settlement apparatus 11 and the cash accounting apparatus 21, the cash transport cassette 30 is configured to store cash therein such that the cash cannot be taken out therefrom.

A clerk transports cash between the cash settlement apparatus 11 and the cash accounting apparatus 21, by using the cash transport cassette 30. For example, when a change fund is loaded, a clerk transports cash having been dispensed from the cash accounting apparatus 21 to be loaded to the cash settlement apparatus 11, from the cash accounting apparatus 21 to the cash settlement apparatus 11, by using the cash transport cassette 30. In addition, when sales proceeds are collected, a clerk transports cash having been collected from the cash settlement apparatus 11 to be deposited to the cash accounting apparatus 21, from the cash settlement apparatus 11 to the cash accounting apparatus 21, by using the cash transport cassette 30. Since the clerk cannot touch the cash in the cash transport cassette 30 during cash transporting, the cash can be transported safely in terms of security.

The cash transport cassette 30 may be configured to be capable of storing and feeding any one of a banknote and a coin, or may be configured to be capable of storing and feeding both a banknote and a coin.

The cash transport cassette 30 for banknote (banknote cassette 30a) may be a cassette of a stacking type in which banknotes are stacked on one another, or may be a cassette of a tape reeling type in which banknotes, which are sandwiched, one by one, by one tape or a plurality of tapes, are reeled up together with the tapes. The cash transport cassette 30 for coin may be a cassette configured to store coins in a denomination mixed state.

The cash transport cassette 30 includes a memory unit configured to store identification information (cassette ID) for specifying the cash transport cassette 30 and information related to stored cash (an amount for each denomination and so on). When the cash transport cassette 30 is of a tape reeling type, the memory unit is configured to store a storing order of cash stored in the cash transport cassette 30, and information relating to a denomination, an authenticity and so on of each cash.

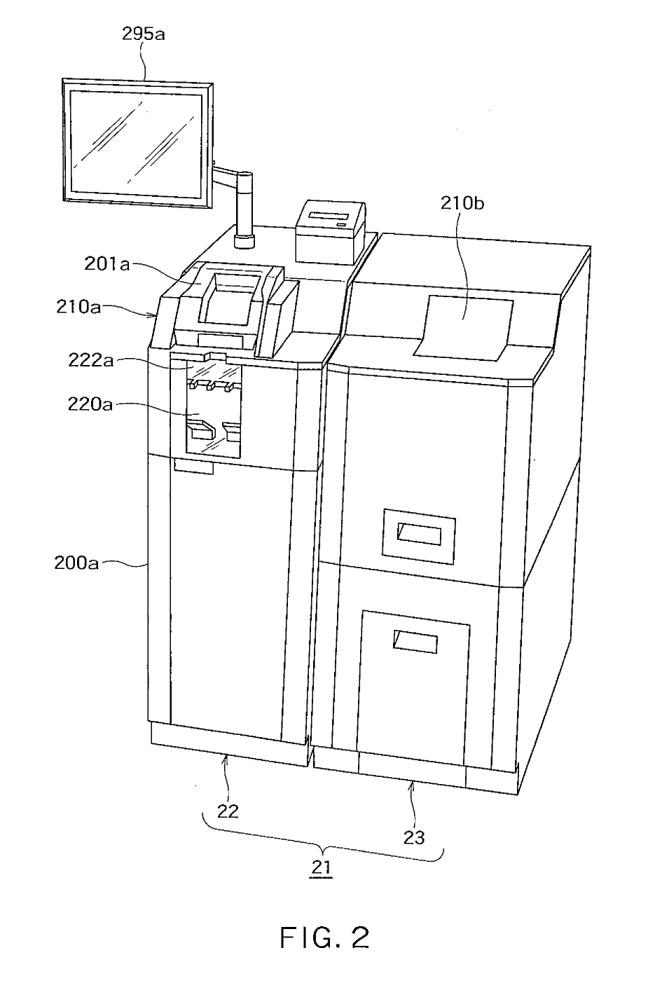

FIG. 2 is a view showing an example of an appearance of the cash accounting apparatus 21. The cash accounting apparatus 21 includes a banknote accounting apparatus 22 and a coin accounting apparatus 23. The banknote accounting apparatus 22 is configured to dispense a banknote to be loaded to the banknote settlement apparatus 12, and configured to deposit a banknote having been collected from the banknote settlement apparatus 12. The coin accounting apparatus 23 is configured to dispense a coin to be loaded to the coin settlement apparatus 13, and configured to deposit a coin having been collected from the coin settlement apparatus 13.

Next, a structure of the banknote accounting apparatus as a banknote handling apparatus is described. The banknote accounting apparatus 22 includes a housing 200a, a depositing unit 210a, a dispensing unit 220a and an operation display unit 295a. As will be described in detail below, the banknote accounting apparatus 22 is configured to be capable of receiving a banknote from a banknote feeding unit. The banknote feeding unit is a unit capable of feeding a banknote(s). The banknote feeding unit includes a banknote receiving unit 201a configured to receive a banknote(s) from an outside of the banknote accounting apparatus 22 and configured to feed the banknotes one by one, and a banknote cassette 30a configured to store a banknote(s) therein and configured to feed the banknote(s) stored therein.

As shown in FIGS. 4A and 4B, the depositing unit 210a is disposed on an end portion 231a of a transport unit 230a, and is configured such that the banknote feeding unit can be attached (deposited) thereon. When the banknote feeding unit is attached to the depositing unit 210a, a banknote having been fed out from the banknote feeding unit can be transported into the banknote accounting apparatus 22 through the end portion 231a of the transport unit 230a. Namely, the depositing unit 210a connects the banknote feeding unit and the transport unit 230a to each other, such that a banknote having been fed out from the banknote feeding unit can be transported into the apparatus from the end portion 231a of the transport unit 230a. Thus, the depositing unit 210a may be referred to as banknote-feeding-unit connecting unit. For example, when a clerk manually deposits a banknote to the banknote accounting apparatus 22, the banknote receiving unit 201a is attached to the depositing unit 210a. On the other hand, when a clerk deposits a banknote to the banknote accounting apparatus 22 by using the banknote cassette 30a (hereinafter referred to also as “cassette depositing”), the banknote cassette 30a, in place of the banknote receiving unit 201a, is attached to the depositing unit 210a (see FIG. 4B). Namely, the banknote accounting apparatus 22 is configured such that the banknote cassette 30a, in place of the banknote receiving unit 201a, can be attached to and detached from the depositing unit 210a.

Not limited to the banknote receiving unit 201a and the banknote cassette 30a, the depositing unit 210a may be configured such that a banknote feeding unit of another structure can be connected thereto.

The dispensing unit 220a is provided for dispensing a banknote to an outside of the banknote accounting apparatus 22.

The operation display unit 295a is configured to display conditions of the cash management apparatus 21, the cash settlement apparatus 11 and the cash transport cassette 30, and configured such that an operator such as a clerk can input instructions and data therethrough. The operation display unit 295a may be a display of a touch panel type. The operation display unit 295a is disposed on any one of the banknote accounting apparatus 22 and the coin accounting apparatus 23, and is commonly used to display information of both. In addition, as means for operating the cash settlement apparatus 21, a card reader (not shown) may be disposed on the banknote accounting apparatus 22.

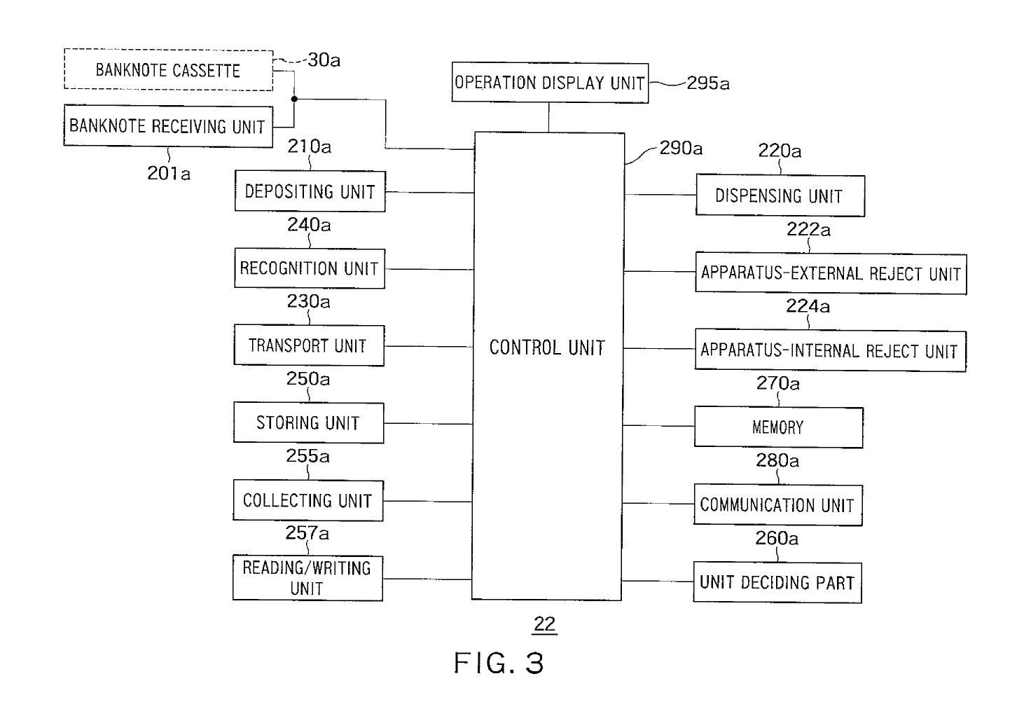

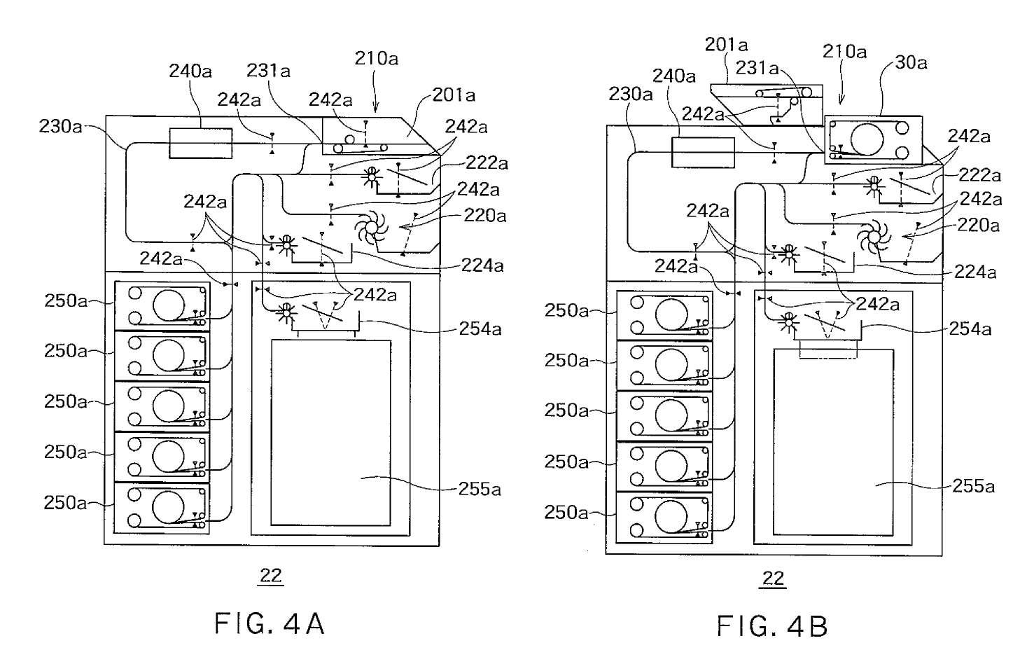

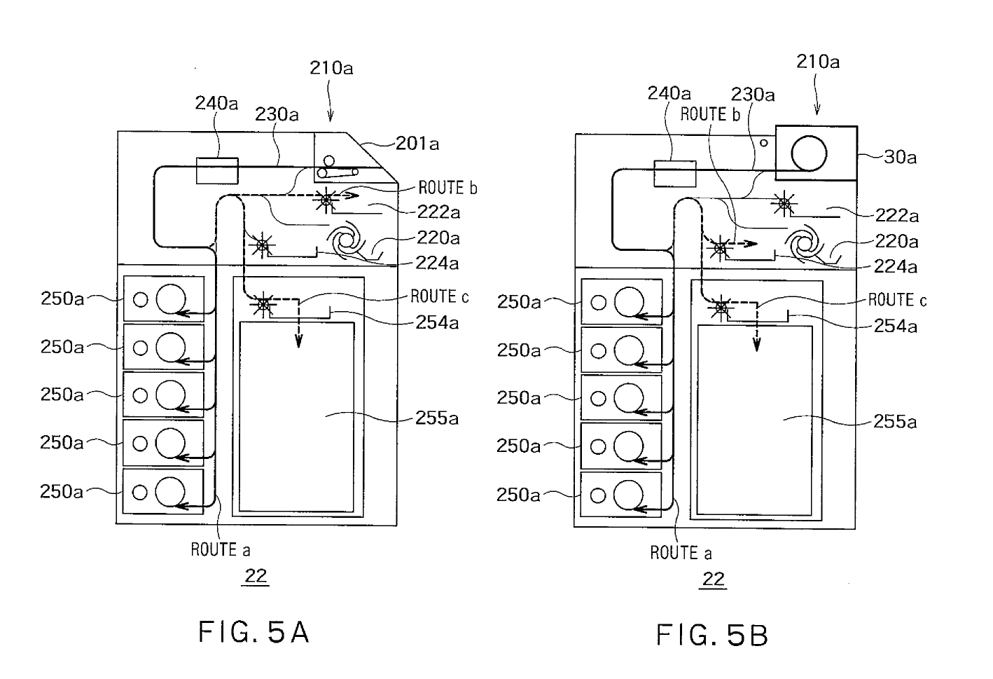

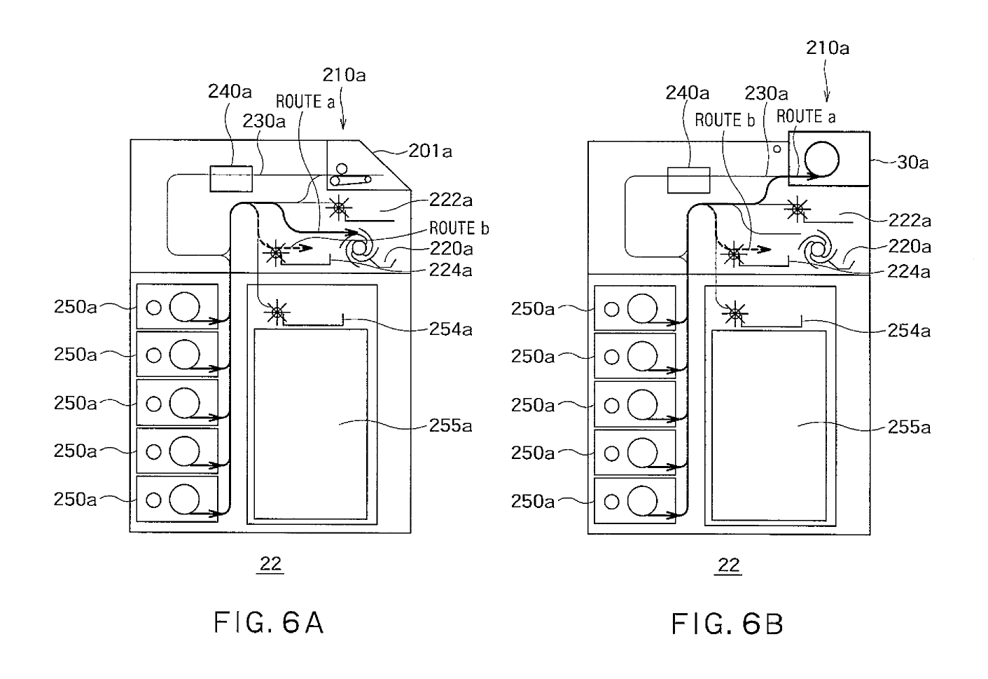

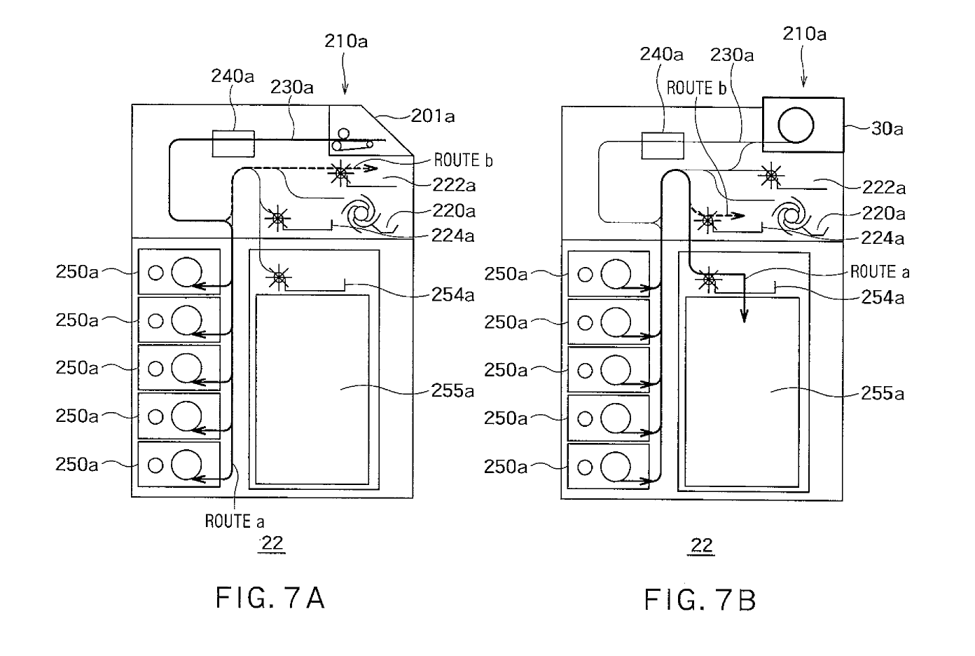

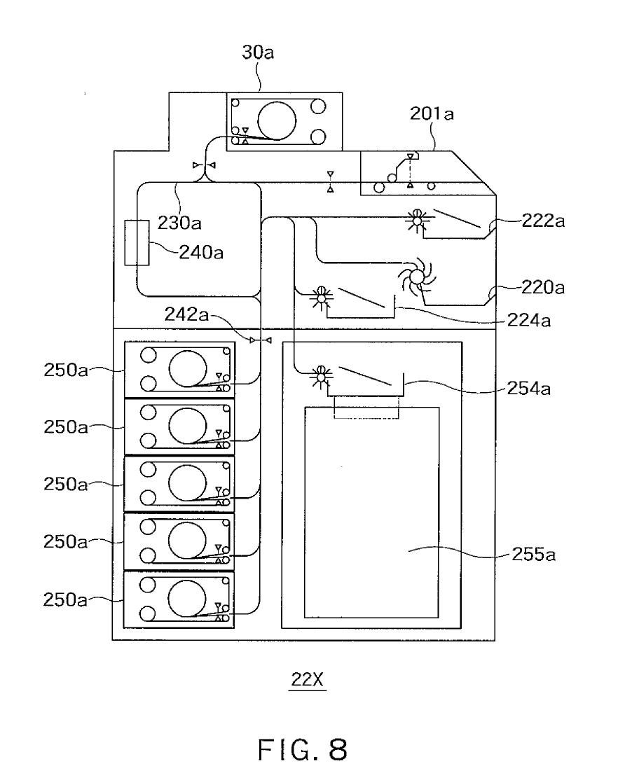

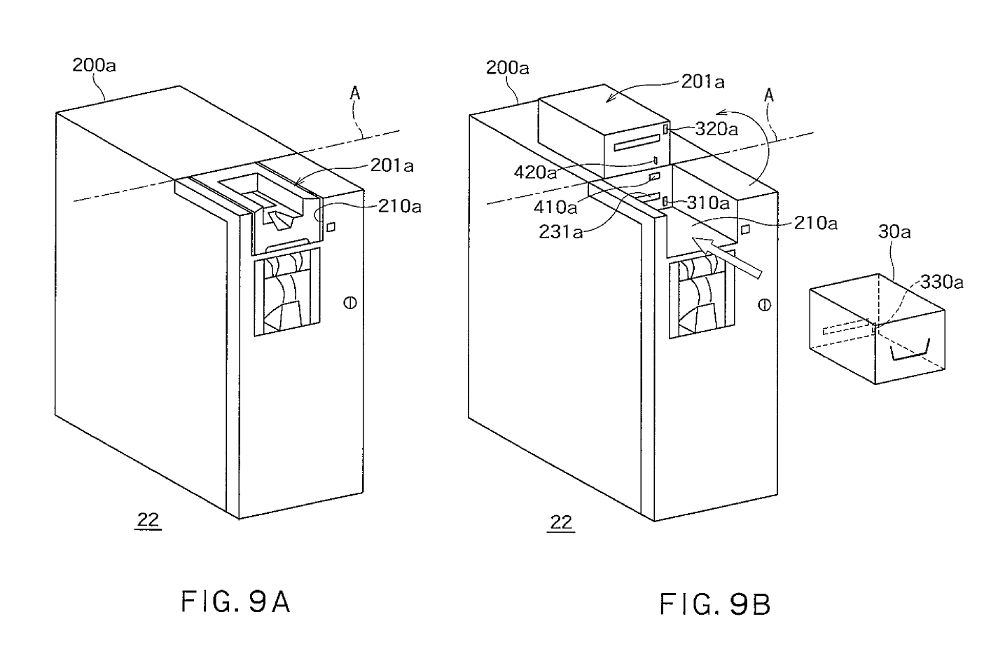

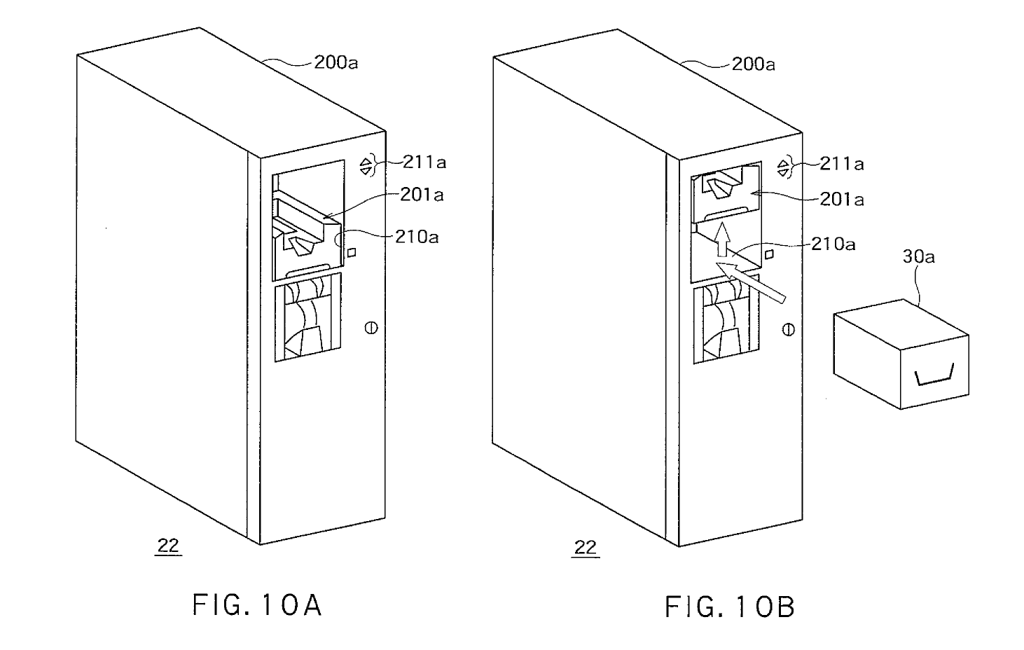

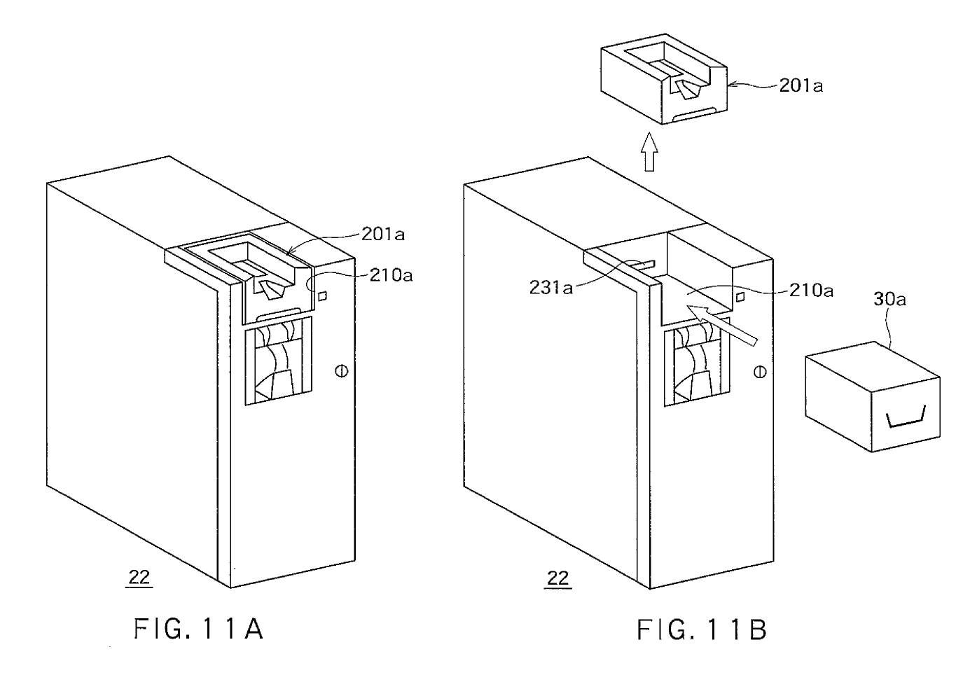

FIG. 3 is a block view showing a structural example of the banknote accounting apparatus 22. In addition to the aforementioned depositing unit 210a, the dispensing unit 220a and the operation display unit 295a, the banknote accounting apparatus 22 further includes the transport unit 230a, a recognition unit 240a, a storing unit 250a, a collecting unit 255a, a reading/writing unit 257a, a unit deciding part 260a, an apparatus-external reject unit 222a, an apparatus-internal reject unit 224a, a memory 270a, a communication unit 280a and a control unit 290a.

The transport unit 230a is configured such that the banknote feeding unit is connected thereto, and configured to transport a banknote having been received into the apparatus. In more detail, the transport unit 230a is configured to transport, to the storing unit 250a, a banknote having been put into the banknote receiving unit 201a attached to the depositing unit 210a, or configured to transport, from the storing unit 250a, a banknote to be dispensed from the dispensing unit 220a. In addition, the transport unit 230a is configured to transport a banknote from the storing unit 250a to the banknote cassette 30a, or configured to transport a banknote from the banknote cassette 30a to the storing unit 250a. As shown in FIGS. 4A and 4B, sensors 242a such as photosensors are disposed on the transport unit 230a and predetermined locations. The sensors 242a are configured to detect presence of a banknote and passage of a banknote.

The recognition unit 240a includes a sensor such as a magnetic sensor, a fluorescent sensor, a metal thread sensor, a thickness sensor or an image sensor, and is configured to recognize whether a banknote being transported by the transport unit 230a is an acceptable banknote or a reject banknote that is unacceptable, by comparing a feature of each banknote stored therein and a sensor output with each other. The reject banknote is, for example, a paper sheet other than a banknote, a foreign banknote not to be handled, and a banknote that cannot be recognized because it is torn or stained. In addition, banknotes which are transported in an overlapped state, and banknotes which are transported with an interval therebetween being smaller than a predetermined interval, are also handled as reject banknotes.

Further, the recognition unit 240a is configured to recognize a denomination, an authenticity, a fitness (fit note/unfit note), an version and so on of a banknote that is not a reject banknote. The fit note and the unfit note are banknotes whose denomination can be recognized, but the fit note is a banknote suited for circulation and the unfit note is a banknote unsuited for circulation because it is torn or stained.

The storing unit 250a is configured to store, by denomination, banknotes having been recognized by the recognition unit 240a, and configured to feed, one by one, banknotes stored therein. The storing unit 250a may be a storing unit of a stacking type or a storing unit of a tape reeling type. The collecting unit 255a is used when a banknotes stored in the storing unit 250a is collected. The collecting unit 255a is made of a box or a pouch.

The reading/writing unit 257a is wiredly or wirelessly connected communicably to the memory unit disposed on the banknote cassette 30a, and is configured to read out information stored in the memory unit or configured to write information to the memory unit. The memory unit of the banknote cassette 30a stores at least cassette ID information for specifying the banknote cassette 30a, and may store information related to a banknote stored in the banknote cassette 30a, such as a denomination and an amount of the banknote, according to need. In addition, the communication unit 280a in place of the reading/writing unit 257a may receive information (e.g., a denomination and an amount of a stored banknote) other than cassette ID from the banknote settlement apparatus 12 that has stored a banknote to the banknote cassette 30a, through a communication line such as LAN.

The unit deciding part 260a is configured to decide the banknote feeding unit for feeding a banknote. More specifically, the unit deciding part 260a is configured to decide the banknote feeding unit for feeding a banknote, based on a connection condition of the banknote feeding unit to the transport unit 230a. The unit deciding part 260a recognizes a connection condition of the banknote feeding unit to the transport unit 230a, by means of information from a set detection sensor and a unit connector, and decides the banknote feeding unit for feeding a banknote. The set detection sensor is a sensor configured to detect that the banknote receiving unit 201a has been attached to the depositing unit 210a. The set detection sensor is formed of, e.g., a photo interrupter. When a light shielding plate disposed on the banknote receiving unit 201a shields light, the photo interrupter detects that the banknote receiving unit 201a has been attached to the depositing unit 210a. The unit connector is connected to terminals (connectors) of the banknote receiving unit 201a and the banknote cassette 30 so that the banknote receiving unit 201a and the banknote cassette 30a are connected to a driving power source line and a signal line.

The unit deciding part 260a is configured to detect whether the banknote feeding unit is attached to the depositing unit 210a or not, from a conducting condition of the unit connector, and configured to detect a kind of the banknote feeding unit attached to the depositing unit 210a, by means of the set detection sensor.

The banknote accounting apparatus 22 can access (read and write) the memory unit in the banknote cassette 30a through the unit connector. In this case, the unit deciding part 260a can recognize a kind of the banknote feeding unit based on recognition information stored in the memory unit. In addition, the banknote receiving unit 201a may have a memory unit configured to store recognition information and so on. In this case, the unit deciding part 260a can recognize a kind of the banknote feeding unit, based on the recognition information stored in the memory unit of the banknote receiving unit 201a.

When the set detection sensor and the unit connector are used, the unit deciding part 260a is configured to detect attachment of the banknote feeding unit by the unit connector. When the unit deciding part 260a detects attachment of the banknote receiving unit 201a by means of the set detection sensor, the unit deciding part 260a is configured to detect that a banknote is fed out from the banknote receiving unit 201a. On the other hand, when the unit deciding part 260a detects attachment of the banknote feeding unit by means of the unit connector and does not detect attachment of the banknote receiving unit 201a by means of the set detection sensor, the unit deciding part 260a is configured to decide that a banknote is fed out from the banknote cassette 30a.

The unit deciding part 260a may decide the banknote feeding unit for feeding a banknote, based on process contents having been received by the operation display unit 295a and the cash management apparatus 25 and so on (hereinafter referred to as “process reception unit”). Thus, for example, when both the banknote receiving unit 201a and the banknote cassette 30a can be simultaneously attached to a banknote handling apparatus 22X which will be described below, a user can instruct from which a banknote is to be fed out, through the process reception unit.

The apparatus-external reject unit 222a and the apparatus-internal reject unit 224a are both provided for stacking reject banknotes. The apparatus-external reject unit 222a is configured to store a banknote, which has been recognized as a reject banknote by the recognition unit 240a, such that the banknote can be take out from the outside of the banknote accounting apparatus 22. On the other hand, the apparatus-internal reject unit 224a is configured to store a banknote, which has been recognized as a reject banknote by the recognition unit 240a, such that the banknote is securely stored in the banknote accounting apparatus 22. The apparatus-internal reject unit 224a is disposed inside the housing 200a, and configured to store a banknote in the apparatus. Thus, a user who does not have a management authority, such as a clerk, cannot take out the banknote in the apparatus-internal reject unit 224a.

The memory 270a includes various programs for controlling the cash accounting apparatus 22, a ORM or a HDD storing data, and a RAM serving as a program loading area or a working area when a program is executed, and so on. Further, the memory 270a is configured to store information (a denomination, an amount and so on) of a banknote stored in the storing unit 250a and the collecting unit 255a. Furthermore, the memory 270a is configured to store contents of a process having performed by the banknote accounting apparatus 22 (date and time, a process type, a banknote transport destination, a denomination of a processed banknote, quantities of a fit note(s) and an unfit note(s), an operator's ID, etc.). When the storing unit 250a is a storing unit of a tape reeling type, the memory 270a is configured to store a storing order of banknotes stored in the storing unit 250a and information such as a denomination, a fitness and so on of each of the banknotes.

The communication unit 280a is provided for communication with other apparatuses (the cash settlement apparatus 11, the cash management apparatus 25, the POS management apparatus 26 and so on) which constitute the cash handling system 1.

The control unit 290a is configured to execute a program in the memory 270a to control the banknote accounting apparatus 22 as a whole. When the recognition unit 240a recognizes banknote having been received from the banknote feeding unit as a reject banknote, the control unit 290a is configured to decide to which one (destination) of the apparatus-internal reject unit 224a and the apparatus-external reject unit 222a the reject banknote is transported, based on the banknote feeding unit having fed the banknote. For example, the control unit 290a is configured to decide that a reject banknote having been received from the banknote receiving unit 201 is transported to the apparatus-external reject unit 222a, and configured to decide that a reject not having been received from the banknote cassette 30 is transported to the apparatus-internal reject unit 224a. Then, the control unit 290a controls the transport unit 230a such that the reject banknote is transported to the decided transport destination.

Since banknotes in the banknote cassette 30a have been once recognized when the banknotes were stored into the banknote cassette 30a, it can be considered that all the banknotes are not reject banknotes. However, actually, depending on properties of recognition unit of each apparatus and differences in level setting, there is a possibility that a banknote, which has been judged as a fit note upon cassette depositing, might be judged as an unfit note or a reject banknote. In addition, when banknotes including a reject banknote are collected, there is a possibility that a reject banknote might be stored into the banknote cassette 30.

Next, an example of an inside structure of the banknote accounting apparatus 22 is described with reference to FIGS. 4A and 4B.

FIG. 4A and FIG. 4B are sectional views each showing an example of an inside structure of the banknote accounting apparatus 22. FIG. 4A shows a condition in which the banknote receiving unit 201a is attached to the depositing unit 210a, and FIG. 4B shows a condition in which the banknote cassette 30a is attached to the depositing unit 201a. In FIGS. 4A and 4B, illustration of the operation display unit 295a is omitted.

As shown in FIG. 4A, when a banknote is deposited to the banknote accounting apparatus 22 by using the banknote receiving unit 201a, a clerk attaches the banknote receiving unit 201a to the depositing unit 210a. Thus, the unit deciding part 260a decides the banknote receiving unit 201a as the banknote feeding unit, and a banknote having been put into the banknote receiving unit 201a is fed to the transport unit 230a.

On the other hand, as shown in FIG. 4B, when a banknote in the banknote cassette 30a is deposited to the banknote accounting apparatus 22, a clerk attaches the banknote cassette 30a to the depositing unit 210a. Thus, the unit deciding part 260a decides the banknote cassette 30 as the banknote feeding unit, and a banknote stored in the banknote cassette 30a is fed to the transport unit 230a.

When a banknote is dispensed from the banknote accounting apparatus 22, the storing unit 250a feeds, one by one, a banknote(s) to the transport unit 230a. The transport unit 230a transports the fed banknote to the dispensing unit 220a so as to dispense the banknote.

In this manner, the banknote accounting apparatus 22 can store a banknote having been put into the banknote receiving unit 201a into the storing unit 250a, and can reversely dispense a banknote stored in the storing unit 250a to the dispensing unit 220a. Namely, the banknote accounting apparatus 22 is configured to reuse a deposited banknote as a banknote to be dispensed.

When a banknote(s) is loaded to the banknote settlement apparatus 12, the storing unit 250a feeds, one by one, banknotes to the transport unit 230a, in order that the banknotes are transported to the banknote cassette 30a. The transport unit 230a dispenses the fed banknotes to the banknote cash transport cassette 30a. Thus, the banknote accounting apparatus 22 can dispense, to the banknote cassette 30a, the banknotes to be loaded to the banknote settlement apparatus 12. When a banknote(s) is collected from the banknote settlement apparatus 12, the banknote cassette 30a feeds, one by one, a banknote(s) stored therein to the transport unit 230a. The transport unit 230a stores the fed banknote into the storing unit 250a.

In this manner, the banknote accounting apparatus 22 is configured to dispense, to the banknote cassette 30a, a banknote to be loaded to the banknote settlement apparatus 12, or configured to deposit, from the banknote cassette 30a, a banknote having been collected from the banknote settlement apparatus 12.

Next, a depositing/dispensing process of the banknote accounting apparatus 22 is described in more detail with reference to the drawings. The depositing/dispensing process is roughly classified into a depositing process, a dispensing process, a replenishing process and a collecting process. The respective processes are described with reference to FIGS. 5A to 7B.

(Depositing Process)

A depositing process is a process by which a banknote is deposited to the banknote accounting apparatus 22. For example, the depositing process is performed when a banknote having been collected from the banknote settlement apparatus 12 is deposited to the banknote accounting apparatus 22. A banknote can be deposited, by using either the banknote receiving unit 201a or the banknote cassette 30a.

FIG. 5A shows transport routes (a route a, a route b and a route c) of a banknote to be deposited, when the banknote receiving unit 201a is attached to the depositing unit 210a.

When a clerk has put a banknote(s) to the banknote receiving unit 201a and the process reception unit has received a depositing instruction, the banknote receiving unit 201a feeds, one by one, the banknotes having been put thereinto, to the transport unit 230a. The transport unit 230a causes the fed banknotes to pass through the recognition unit 240a so as to recognize whether each banknote is a reject banknote or not Based on the recognition result, when a banknote is a normal banknote (that is not a reject banknote), the transport unit 230a transports the banknote to the storing unit 250a corresponding to a denomination of the banknote (the route a in FIG. 5A). Even when the banknote is a normal banknote but the storing unit 250a is full, the transport unit 230a transports the banknote to a collecting and stacking unit 254a (the route c in FIG. 5A). The collecting and stacking unit 254a stacks banknotes having been transported thereto, and opens a bottom surface of the collecting and stacking unit 254a so as to let down the stacked banknotes. Thus, the banknotes stacked in the collecting and stacking unit 254a are stored into the collecting unit 255a. When the number of banknotes stacked in the collecting and stacking unit 254a exceeds a full number (the maximum number of stackable banknotes), the transport of a banknote to the collecting and stacking unit 254a is stopped. After banknotes stacked therein have been stored into the collecting unit 255a, the transport is restarted.

On the other hand, when a banknote has been recognized as a reject banknote by the recognition unit 240a, the transport unit 230a transports the reject banknote to the apparatus-external reject unit 222a (the route b in FIG. 5A).

FIG. 5B shows transport routes (a route a, a route b and a route c) of a banknote to be deposited, when the banknote cassette 30a is attached to the depositing unit 210a.

When the process reception unit has received a depositing instruction, the cassette 30a feeds, one by one, banknotes stored therein, to the transport unit 230a. The transport unit 230a causes the fed banknotes to pass through the recognition unit 240a so as to recognize whether each banknote is a reject banknote or not. Based on the recognition result, when a banknote is a normal banknote, the transport unit 230a transports the banknote to the storing unit 250a corresponding to a denomination of the banknote (the route a in FIG. 5B). Even when the banknote is a normal banknote but the storing unit 250a is full, the transport unit 230a transports the banknote to the collecting and stacking unit 254a so as to be stored into the collecting unit 255a (the route c in FIG. 5B).

On the other hand, when a banknote has been recognized as a reject banknote by the recognition unit 240a, the transport unit 230a transports the reject banknote to the apparatus-internal reject unit 224a (the route b in FIG. 5B).

As described above, the banknote accounting apparatus 22 changes a transport destination of the reject banknote having been received into the apparatus, depending on whether the reject banknote is a banknote having been fed out from the banknote receiving unit 201a or a banknote having been fed out from the banknote cassette 30a. To be more specific, when the reject banknote is a banknote having been fed out from the banknote receiving unit 201a, the control unit 290a controls the transport unit 230a such that the reject banknote is transported to the apparatus-external reject unit 222a. On the other hand, when the reject banknote is a banknote having been fed out from the banknote cassette 30a, the control unit 290a controls the transport unit 230a such that the reject banknote is transported to the apparatus-internal reject unit 224a. The contents of the depositing process are stored in the memory 270a.

Since a reject banknote in the banknote cassette 30 is transported to be stored into the apparatus-internal reject unit 224a disposed inside the housing 200a, a user who does not have a management authority, such as a clerk, cannot touch the banknote having been stored in the banknote cassette 30a, whereby the security of a banknote in the banknote cassette 30a can be maintained. In addition, during the cassette depositing, when the banknote accounting apparatus 22 can recognize a storing order of banknotes in the banknote cassette 30a and information of each banknote such as a denomination, a fitness and so on, from the memory unit of the banknote cassette 30a, for example, the depositing process can be performed without the banknotes being recognized in the banknote accounting apparatus 22.

(Dispensing Process)

A dispensing process is a process by which a banknote is dispensed from the banknote accounting apparatus 22. For example, the dispensing process is performed when a banknote is replenished to the banknote settlement apparatus 12. A banknote can be dispensed, by using either the banknote receiving unit 201a or the banknote cassette 30a. FIG. 6A shows a transport route of a banknote to be dispensed when the banknote receiving unit 201 is attached to the depositing unit 210a (a route a), and FIG. 6B shows transport routes of a banknote to be dispensed when the banknote cassette 30a is attached to the depositing unit 210a (the route a and a route b).

When the process reception unit has received a dispensing instruction, the storing unit 250a feeds, one by one, banknotes stored therein, to the transport unit 230a. The transport unit 230a causes the fed banknotes to pass through the sensor 242a, and the sensor 242a recognizes whether each banknote is a reject banknote or not. Based on the recognition result, when a banknote is a normal banknote, the transport unit 230a transports the banknote to the dispensing unit 220a if the banknote receiving unit 201a is attached, or transports the banknote to the banknote cassette 30a if the banknote cassette 30a is attached (the route a in FIGS. 6A and 6B).

The banknotes having been transported to the banknote cassette 30a are stored into the banknote cassette 30a, and the memory unit of the banknote cassette 30a stores the number of the stored banknotes for each denomination. When the banknote cassette 30a is of a tape reeling type, the memory unit stores a storing order of the banknotes and information of each banknote such as a denomination, a fitness and so on.

On the other hand, when a banknote has been recognized as a reject banknote by the sensor 242a, the transport unit 230a transports the reject banknote to the apparatus-internal reject unit 224a, regardless of the banknote feeding unit attached to the depositing unit 210a (the route b in FIGS. 6A and 6B). The contents of the dispensing process are stored in the memory 270a.

(Replenishing Process)

A replenishing process is a process by which a banknote is replenished to the banknote accounting apparatus 22. For example, the replenishing process is performed when a banknote in a safe is deposited to the banknote accounting apparatus 22. When the process reception unit has received a replenishing instruction, the replenishing process is performed similarly to the depositing process.

FIG. 7A shows a transport route of a banknote having been replenished from the banknote receiving unit 201a. Namely, a route in FIG. 7A shows a transport route of a banknote having been recognized to be normal by the recognition unit 240a, and a route b shows a transport route of a banknote having been recognized as a reject banknote by the recognition unit 240a. As can be understood from FIG. 7A, the banknote transport routes in the replenishing process are the same as the banknote transport routes in the depositing process (the route a and the route b in FIG. 5A). The contents of the replenishing process are store in the memory 270a.

(Collecting Process)

A collecting process is a process by which a banknote in the banknote accounting apparatus 22 is collected. For example, the collecting process is performed when a banknote in the banknote accounting apparatus 22 is dispensed to a safe. FIG. 7B shows a transport route of a banknote having been stored in the storing unit 250a, in the collecting process. Namely, a route 1 in FIG. 7B shows a transport route of a banknote having been recognized to be normal by the sensor 242a, and a route b shows a transport route of a banknote having been recognized as a reject banknote by the sensor 242a.

As shown in FIG. 7B, in the collecting process, when the process reception unit has received a collecting instruction, a normal banknote in the storing unit 250a is transported to the collecting unit 255a, and a reject banknote is transported to the apparatus-internal reject unit 224a. The banknote having been transported to the collecting unit 255a is taken out to the outside of the banknote accounting apparatus 22, by a user who has a management authority. When the collecting unit 255a becomes full in the course of the collecting process, the collecting unit 255a is replaced with another vacant collecting unit 255a, whereby the collecting process can be continued. The contents of the collecting process are stored in the memory 270a.

In the depositing process and the replenishing process, as to a banknote having been recognized as a banknote of a specific type by the recognition unit 240a, even when the banknote has been deposited from the banknote receiving unit 201a, the transport unit 230a may transport the banknote to the apparatus-internal reject unit 224a. For example, in order to prevent circulation of a banknote of category 2 (counterfeit banknote) and a banknote of category 3 (suspicious banknote), which are set up by EC Forum Regulation 1338, paragraph 6, such banknotes are preferably transported to the apparatus-internal reject unit 224a, regardless of a type of the banknote feeding unit.

In addition, not limited to an instruction from the process reception unit, change of a transport destination of a reject banknote having been received from the banknote cassette 30a may be performed based on the information related to a stored banknote, which is stored in the memory unit of the banknote cassette 30a. For example, when information showing that a paper sheet (e.g., a check), which has been fed out n^{th} from the banknote cassette 30a, is other than a banknote is stored in the memory unit of the banknote cassette 30a, the control unit 290a may perform a control process such that the paper sheet, which has been fed out n^{th} from the banknote cassette, is transported to the apparatus-external reject unit 222a.

Although one of the banknote receiving unit 201a and the banknote cassette 30a is attached to the depositing unit 210a of the banknote accounting apparatus 22, the present invention is not limited thereto. Namely, the present invention includes a banknote accounting apparatus on which the banknote receiving unit 201a and the banknote cassette 30a are simultaneously attachable.

FIG. 8 is a sectional view showing an inside structure of such a banknote accounting apparatus 22X. Both the banknote receiving unit 201a and the banknote cassette 30a are attached to the banknote accounting apparatus 22X.

As shown in FIG. 8, the transport unit 230a is configured to be capable of transporting a banknote to a predetermined part in the apparatus (the storing unit 250a, the apparatus-internal reject unit 224a, the apparatus-external reject unit 222a and the collecting and stacking unit 254a), irrespective of whether the banknote has been received from the banknote receiving unit 201a or the banknote cassette 30a. In addition, as shown in FIG. 8, the recognition unit 240a is disposed on the transport unit 230a that is common to a banknote having been fed out from the banknote receiving unit 201a and a banknote having been received from the banknote cassette 30a.

The control unit 290a performs a control process such that a reject banknote having been received from the banknote receiving unit 201a is transported to the apparatus-external reject unit 222a, and performs a control process such that a reject banknote having been received from the banknote cassette 30a is transported to the apparatus-internal reject unit 224a.

In the banknote accounting apparatus 22X, a user can optionally select the banknote feeding unit, by giving an instruction to the process reception unit. Based on the process contents having been received by the process reception unit, the unit deciding part 260a decides the banknote feeding unit for feeding a banknote.

In the aforementioned description, two kinds of banknote feeding units (the banknote receiving unit 201a and the banknote cassette 30a) can be attached to the banknote accounting apparatuses 22 and 22X. However, not limited thereto, the present invention can be applied to a banknote accounting apparatus capable of receiving a banknote from three or more kinds of banknote feeding units.

As described above, the banknote handling apparatus 22 in this embodiment is capable of receiving a banknote from at least two kinds of banknote feeding units (e.g., the banknote receiving unit 201a and the banknote cassette 30a), and includes the apparatus-internal reject unit 224a configured to store a reject banknote inside the banknote handling apparatus 22, and the apparatus-external reject unit 222a configured to dispense a reject banknote to the outside of the banknote handling apparatus 22. In addition, the banknote handling apparatus 22 includes the unit deciding part 260a configured to decide the banknote feeding unit for feeding a banknote, and the control unit 290a configured to decide, when the recognition unit 240a has recognized that a banknote having been received from the banknote feeding unit is a reject banknote, to which one of the apparatus-internal reject unit 224a and the apparatus-external reject unit 222a the reject banknote is transported, depending on the banknote feeding unit having fed the banknote.

According to such a banknote handling apparatus 22, depending on the banknote feeding unit having fed the banknote, whether the reject banknote is transported to the apparatus-internal reject unit 224a or the apparatus-external reject unit 222a is automatically decided. As a result, since it is not necessary for a user to instruct the transport destination of the reject banknote, the banknote accounting apparatus 22 can be easier to handle.

In addition, as described above, in the banknote handling apparatus 22 in this embodiment, the unit deciding part 260a decides the banknote feeding unit for feeding a banknote, based on a connection condition of the banknote feeding unit to the transport unit 230a. Thus, the unit deciding part 26 can decide the banknote feeding unit for feeding a banknote, without any instruction from a user.

In addition, as described above, the banknote handling apparatus 22 in this embodiment further includes the process reception unit (the operation display unit 295a, the cash management apparatus 25 and so on). Based on the process contents having been received by the process reception unit, the unit deciding part 260a decides the banknote feeding unit for feeding a banknote. Thus, when both the banknote receiving unit 201a and the banknote cassette 30a are simultaneously attachable, as in the case of the banknote handling apparatus 22X, a user can instruct whether a banknote is fed out from the banknote receiving unit 201a or the banknote cassette 30a, through the process reception unit.

In addition, as described above, in the banknote handling apparatus 22 in this embodiment, the banknote feeding unit includes the banknote receiving unit 201a configured to receive a banknote(s) from outside and configured to feed, one by one, the banknotes, and the banknote cassette 30a configured to store a banknote(s) and configured to feed the banknotes stored therein.

In addition, as described above, in the banknote handling apparatus 22 in this embodiment, the control unit 290a performs a control process such that a reject banknote having been received from the banknote receiving unit 201a is transported to the apparatus-external reject unit 222a, and that a reject banknote having been received from the banknote cassette 30a is transported to the apparatus-internal reject unit 224a. Thus, even when a banknote in the banknote cassette 30a is a reject banknote, a person other than a user having a management authority cannot touch the reject banknote, whereby consistency in security can be ensured.

In addition, as described above, the banknote handling apparatus 22 in this embodiment further has the process reception unit (the operation display unit 295a, the cash management apparatus 25, etc.) configured to receive an instruction for process, and the control unit 290a performs a control process such that a reject banknote having been received from the banknote cassette 30a is transported to the apparatus-external reject unit 222a, depending on an instruction having been received by the process reception unit. Thus, when it is necessary to perform an irregular process that is different from an ordinary process, the banknote handling apparatus 22 can deal with the case. For example, when a user having a management authority wants to observe and confirm a reject banknote in the banknote cassette 30a, the banknote handling apparatus 22 can deal with the case.

It is desirable that the banknote cassette is attachable at a height where a user such as a clerk can easily operate the banknote cassette, and that a banknote can be manually deposited at such a height, while preventing enlargement of the banknote accounting apparatus. That is to say, it is desirable that a user can perform a depositing/dispensing process by the banknote cassette as well as a manual depositing/dispensing process, at substantially the same height, while maintaining a space of the banknote accounting apparatus as little as possible.

Next, in order to achieve the above object, there are described three embodiments (first to third embodiments) of the banknote handling apparatus 22 on which the banknote cassette 30a is attachable by moving the banknote receiving unit 201a.

In the first embodiment, the banknote receiving unit 201a is integrally formed with the banknote accounting apparatus 22, and is configured to be rotatable about a predetermined axis.

FIGS. 9A and 9B are perspective views of the banknote accounting apparatus 22 in this embodiment. FIG. 9A shows a condition where the banknote receiving unit 201a is attached to the depositing unit 210a, and FIG. 9B shows a condition where the banknote cassette 30a is being attached to the depositing unit 210a.

As shown in FIG. 9B, a unit connector 310a is disposed on the depositing unit 210a. The unit connector 310a is connected to a connector 320a of the banknote receiving unit 201a, or a connector 330a of the banknote cassette 30a.

In addition, as shown in FIG. 9B, a photo interrupter 410a is disposed on the depositing unit 210a. A light-shielding plate 42 configured to shield light from the photo interrupter 410a is disposed on the banknote receiving unit 210a. When the banknote receiving unit 201a is attached to the depositing unit 210a (see FIG. 9A), the light-shielding plate 420 shields light from the photo interrupter 410a.

As shown in FIGS. 9A and 9B, when the banknote cassette 30 in place of the banknote receiving unit 201a is attached, a set lock of the banknote receiving unit 201a is released, and the banknote receiving unit 201a is then brought up and rotated about the axis A, so that the banknote receiving unit 201a is withdrawn onto an upper surface of the housing 200a. At this time, the unit connector 310a and the connector 320a are disconnected from each other, and the light-shielding plate 420a is displaced from the photo interrupter 410a. Thus, the photo interrupter 410a becomes a floodlighting condition where light from a light emitting unit is received by a light receiving unit.

In the first embodiment, the banknote receiving unit 201a is rotated, so that a space for attaching the banknote cassette 30a is provided.

After the banknote receiving unit 201a has been withdrawn, as shown in FIG. 9B, the banknote cassette 30a is attached to the depositing unit 210a. At this time, since a width of the banknote cassette 30a and an interval between side surfaces of the depositing unit 210a are substantially the same with each other, a recessed part defined by a bottom surface and the side surfaces of the depositing unit 210a functions as a guide of the banknote cassette 30a.

When the cassette 30a is attached to the depositing unit 210a, the unit connector 310a and the connector 330a are connected to each other. The banknote cassette 30a is not provided with a light shielding plate such as the light shielding plate 420a. Thus, even when the banknote cassette 30a is attached to the depositing unit 210a, the photo interrupter 410a remains in the floodlighting condition.

In addition, positions of the banknote outlets of the banknote cassette 30a and the banknote receiving unit 201a correspond to a position of the end portion 231a, when the banknote cassette 30 or the banknote receiving unit 201a is attached to the depositing unit 210a. Thus, the banknote cassette 30a attached to the depositing unit 210a is connected to the transport unit 230a, so that a banknote having been fed out from the banknote cassette 30a can be transported into the apparatus by the transport unit 230a.

The aforementioned structure of the banknote receiving unit 201a other than the withdrawal manner is the same as structures in the second and third embodiments.

In the first embodiment, the banknote receiving unit 201a is rotated so as to be withdrawn, and the banknote cassette 30a is attached to the place where the banknote receiving unit 201a has been attached. Thus, it is not necessary to provide an additional space for attaching the banknote cassette 30a. In addition, a depositing/dispensing process by the banknote cassette and a manual depositing/manual dispensing process can be performed at substantially the same height.

Further, a banknote having been fed out from the banknote cassette 30a is transported from the end portion 231a of the transport unit 230a into the apparatus, similarly to a banknote having been fed out from the banknote receiving unit 201a. Thus, it is not necessary to additionally provide a transport path for transporting a banknote having been received from the banknote cassette 30a into the apparatus.

Namely, the banknote accounting apparatus in the first embodiment can deal with both a depositing/dispensing process by the banknote cassette, and a manual depositing/dispensing process. The depositing/dispensing process by the banknote cassette and the manual depositing/dispensing process can be performed a substantially the same height, while a space is saved.

In the below-described second embodiment, the banknote receiving unit 201a is integrally formed with the banknote accounting apparatus 22, and is configured to be vertically translatable by a moving mechanism.

FIGS. 10A and 10B are perspective views of the banknote accounting apparatus 22 in the second embodiment. FIG. 10A shows a condition where the banknote receiving unit 201a is attached to the depositing unit 210a, and FIG. 10B shows a condition where the banknote cassette 30a is being attached to the depositing unit 210a.

As shown in FIGS. 10A and 10B, when the banknote cassette 30a in place of the banknote receiving unit 201a is attached, the banknote receiving unit 201a is translated upward so as to be withdrawn to an upper side of the housing 200a. For example, by pressing down a button 211a for operating a moving mechanism (not shown) configured to vertically translate the banknote receiving unit 201a, the banknote receiving unit 201a is withdrawn to the upper side of the housing 200a. Namely, in the second embodiment, the banknote receiving unit 201a is translated, so that a space for attaching the banknote cassette 30a is provided.

After the banknote receiving unit 201a has been withdrawn, as can be understood from FIG. 10B, the banknote cassette 30a is attached to the depositing unit 210a. Thus, the banknote cassette 30a is connected to the transport unit 230a, whereby a banknote having been fed out from the banknote cassette 30a can be transported into the apparatus by the transport unit 230a.

As can be understood from above, also in the second embodiment, the same effect as that of the first embodiment can be obtained. Further, according to the second embodiment, it is not necessary to make room on the upper surface of the housing 200a as a withdrawal space of the banknote receiving unit 201a. Thus, it is possible to increase a space on the upper surface of the housing 200a where an equipment such as a printer and a card reader can be placed.

In the below-described third embodiment, the banknote receiving unit 201a is configured to be attachable to and detachable from the banknote accounting apparatus 22.

FIGS. 11A and 11B are perspective views of the banknote accounting apparatus 22 in the third embodiment. FIG. 11A shows a condition where the banknote receiving unit 201a is attached to the depositing unit 210a, and FIG. 11B shows a condition where the banknote cassette 30a is being attached to the depositing unit 210a.

As shown in FIGS. 11A and 11B, when the banknote cassette 30a in place of the banknote receiving unit 201a is attached, the banknote receiving unit 201a is detached from the banknote accounting apparatus 22 so as to be withdrawn. Namely, in the third embodiment, the banknote receiving unit 201a is detached from the banknote accounting apparatus 22, so that a space for attaching the banknote cassette 30a is provided.

After the banknote receiving unit 201a has been withdrawn, as can be understood from FIG. 11B, the banknote cassette 30 is attached to the depositing unit 210a. Thus, the banknote cassette 30a is connected to the transport unit 230a, whereby a banknote having been fed out from the banknote cassette 30a can be transported into the apparatus by the transport unit 230a.

As can be understood from above, also in the third embodiment, the same effect as that of the second embodiment can be obtained.

As described above, the banknote handling apparatus 22 in this embodiment includes the transport unit 230a configured to receive a banknote from the end portion 231a and configured to transport the banknote into the banknote handling apparatus 22, and a banknote-feeding-unit connecting unit (depositing unit) 210a configured such that at least two kinds of banknote feeding units (e.g., the banknote receiving unit 201a and the banknote cassette 30a) can be attached thereto, the banknote-feeding-unit connecting unit being configured to connect the banknote feeding unit and the transport unit 230a to each other, such that a banknote having been fed out from the banknote feeding unit is transported from the end portion 231a of the transport unit 230a.

Due to such a structure, according to the banknote handling apparatus 22 in this embodiment, a banknote having been fed out from the banknote feeding unit is transported from the end portion 231a of the transport unit 230a into the apparatus, irrespective of the kind of the banknote feeding unit attached to the depositing unit 210a. Thus, it is not necessary to additionally provide a transport path for transporting a banknote having been fed out from the banknote cassette 30a into the apparatus. As a result, a cost required for the banknote handling apparatus 22 can be reduced.

In addition, as described above, in the banknote handling apparatus 22 in this embodiment, the banknote feeding units are the banknote receiving unit 201a configured to receive a banknote(s) from outside and configured to feed, one by one, the banknotes, and the banknote cassette 30a configured to store a banknote(s) therein and configured to feed out the banknote stored therein.

In addition, as described above, in the banknote handling apparatus 22 in this embodiment, the banknote receiving unit 201a is integrally formed with the banknote handling apparatus 22. The banknote receiving unit 201a is configured to be movable between a first position at which the banknote receiving unit 201a is connected to the transport unit 230a and a second position at which the banknote receiving unit 201a is disconnected from the transport unit 230a. When the banknote receiving unit 201a is placed on the second position, the banknote cassette 30a is attachable to the first position.

Due to such a structure, according to the banknote handling apparatus 22 in this embodiment, it is not necessary to provide an additional space for attaching the banknote cassette 30a. In addition, a banknote having been fed out from the banknote cassette 30a attached to the depositing unit 201a is transported from the end portion 231a of the transport unit 230a into the apparatus, similarly to a banknote having been fed out from the banknote receiving unit 201a. Further, since a user can perform a depositing process by the banknote receiving unit 201a and a depositing process by the banknote cassette 30a at the same height, it is easy to use the banknote handling apparatus 22.

In addition, in the banknote handling apparatus 22 in this embodiment, as described with reference to FIGS. 11A and 11B, the banknote receiving unit 201a may be configured to be attachable to and detachable from the banknote handling apparatus 22.

Based on the above description, those skilled in the art can come up with additional effects and various modifications of the present invention, but the present invention is not limited to the aforementioned embodiments. The present invention can be variously added, modified and partially deleted, without departing from a scope of the claims and a conceptual idea of the present invention derived from an equivalence.
1 Cash management system
10 Checkout counter
11 Cash settlement apparatus
12 Banknote settlement apparatus
13 Coin settlement apparatus
14 Register
20 Back office
21 Cash accounting apparatus
22 Banknote accounting apparatus
23 Coin accounting apparatus
25 Cash management apparatus
26 POS management apparatus
30 Cash transport cassette
30a Banknote cassette
200a Housing
201a Banknote receiving unit
210a Depositing unit
220a Dispensing unit
222a Apparatus-external reject unit
224a Apparatus-internal reject unit
230a Transport unit
231a End portion
240a Recognition unit
242a Sensor
250a Storing unit
254a Collecting and stacking unit
255a Collecting unit
260a Unit deciding part
270a Memory
280a Communication unit
290a Control unit
295a Operation display unit
310a Unit connector
320a, 330a Connector
410a Photo interrupter
420a Light shielding plate

1. A banknote handling apparatus configured to receive a banknote from at least two kinds of banknote feeding units, the banknote handling apparatus comprising:
a transport unit configured such that the banknote feeding unit is connected thereto, the transport unit configured to transport a received banknote;
a recognition unit configured to recognize the banknote being transported;
an apparatus-internal reject unit configured to store a reject banknote inside the banknote handling apparatus;
an apparatus-external reject unit configured to dispense a reject banknote outside the banknote handling apparatus;
a unit deciding part configured to decide the banknote feeding unit for feeding a banknote; and
a control unit configured to decide, when the recognition unit recognizes a banknote having been received from the banknote feeding unit as a reject banknote, to which one of the apparatus-internal reject unit and the apparatus-external reject unit the reject banknote is transported, based on the banknote feeding unit having fed the banknote.

2. The banknote handling apparatus according to claim 1, wherein
the unit deciding part is configured to decide the banknote feeding unit for feeding a banknote, based on a connection condition of the banknote feeding unit to the transport unit.

3. The banknote handling apparatus according to claim 1, further comprising a process reception unit configured to receive an instruction for process,
wherein the unit deciding part is configured to decide the banknote feeding unit for feeding a banknote, based on process contents having been received by the process reception unit.

4. The banknote handling apparatus according to claim 1, wherein
the banknote feeding units are:
a banknote receiving unit configured to receive a banknote(s) from outside and configured to feed the banknotes one by one; and
a banknote cassette configured to store a banknote therein and configured to feed the banknote stored therein.

5. The banknote handling apparatus according to claim 4, wherein
the control unit is configured to perform a control process such that a reject banknote having been received from the banknote receiving unit is transported to the apparatus-external reject unit, and that a reject banknote having been received from the banknote cassette is transported to the apparatus-internal reject unit.

6. The banknote handling apparatus according to claim 5, further comprising a process reception unit configured to receive an instruction for process,
wherein the control unit is configured to perform a control process such that a reject banknote having been received from the banknote cassette is transported to the apparatus-external reject unit, based on an instruction having been received by the process reception unit.

7. The banknote handling apparatus according to claim 5, wherein
the control unit is configured to perform a control process such that a predetermined reject banknote having been received from the banknote cassette is transported to the apparatus-external reject unit, based on information in a memory unit of the banknote cassette, related to a stored banknote.

8. The banknote handling apparatus according to claim 1, further comprising a storing unit configured to store a banknote,
wherein the control unit is configured to perform a control process, when a banknote having been fed out from the storing unit is recognized as a reject banknote by the recognition unit, such that the reject banknote is transported to the apparatus-internal reject unit.
